(19) United States
(12) Patent Application Publication
(10) Pub. No.: US 2026/0288781 A1
(43) Pub. Date: Sep. 24, 2026

(54) SUMMARIZING DOCUMENTS WITH LANGUAGE MODELS USING PAGE AND CONTENT RANKING

(71) Applicant: Schlumberger Technology Corporation, Sugar Land, TX (US)

(72) Inventors: Omkar Anil Gune, Pune (IN); Prashanth Pillai, Pune (IN)

(21) Appl. No.: 19/238,986

(22) Filed: Jun. 16, 2025

(30) Foreign Application Priority Data
Mar. 21, 2025 (IN) 202511026044

(51) Int. Cl. G06F 16/3329; G06F 16/334; G06F 16/383

(52) U.S. Cl. CPC G06F 16/3329; G06F 16/3347; G06F 16/383

(57) ABSTRACT

A method implements summarizing documents with language models using page and content ranking. The method involves processing a document and a query to generate one or more of a set of index pages and a query embedding. The method further involves executing selection instructions to generate a set of selected pages from the document. The set of selected pages includes the one or more of a set of index selected pages and a set of query selected pages. The set of index selected pages is selected using the set of index pages. The set of query selected pages is selected using the query embedding. The method further involves executing summarization instructions to generate a query-based summary using the set of selected pages and content ranking.

### CROSS-REFERENCE TO RELATED APPLICATION

This application claims priority to and the benefit of Indian Application No. 202511026044, entitled “SUMMARIZING DOCUMENTS WITH LANGUAGE MODELS USING PAGE AND CONTENT RANKING,” filed Mar. 21, 2025, which is hereby incorporated by reference in its entirety for all purposes.

### BACKGROUND

Language models (also referred to as large language models (LLMs)) may be used as applications, including chatbot systems and planning agents. One application that may use a language model involves summarizing documents or the sections of documents. In a large document (e.g., more than 100 pages), summarizing the content based on a user query may be challenging, as the content to be summarized may be located on multiple pages, which may be contiguous or noncontiguous. Pertinent information in the document may be “lost in the middle” of the document. Identifying the relevant pages of content for summarization is a non-trivial task. Moreover, summarization itself may be subjective, especially with large documents with noncontiguous content.

### SUMMARY

In general, in one or more aspects, the disclosure relates to a method for summarizing documents with language models using page and content ranking. The method involves processing a document and a query to generate one or more of a set of index pages and a query embedding. The method further involves executing selection instructions to generate a set of selected pages from the document. The set of selected pages includes the one or more of a set of index selected pages and a set of query selected pages. The set of index selected pages is selected using the set of index pages. The set of query selected pages is selected using the query embedding. The method further involves executing summarization instructions to generate a query-based summary using the set of selected pages and content ranking.

In general, in one or more aspects, the disclosure relates to a system that includes at least one processor and an application that executes on the at least one processor. Executing the application performs processing a document and a query to generate one or more of a set of index pages and a query embedding. Executing the application further performs executing selection instructions to generate a set of selected pages from the document. The set of selected pages includes the one or more of a set of index selected pages and a set of query selected pages. The set of index selected pages is selected using the set of index pages. The set of query selected pages is selected using the query embedding. Executing the application further performs executing summarization instructions to generate a query-based summary using the set of selected pages and content ranking.

Other aspects of one or more embodiments may be apparent from the following description and the appended claims.

### BRIEF DESCRIPTION OF DRAWINGS

FIG. 1 shows a diagram in accordance with the disclosure.

FIG. 2 shows a method in accordance with the disclosure.

FIG. 3, FIG. 4, FIG. 5, FIG. 6, FIG. 7, and FIG. 8 show examples in accordance with the disclosure.

Similar elements in the various figures may be denoted by similar names and reference numerals. The features and elements described in one figure may extend to similarly named features and elements in different figures.

### DETAILED DESCRIPTION

Systems of the disclosure generate summaries of documents based on the queries provided by users. A document and a query may be identified in a request from a user and a summary may be provided in a response to the request. A language model may be used to generate the summary. Systems of the disclosure may address the issues identified above (e.g., context length and content getting lost in the middle) by generating intermediate data to rank the pages of the document based on the query and then selecting pages from the document that are relevant to the query. The selected pages may then be used with the query by the language model to generate a summary based on the query.

As an example, a user may provide a query in a request for a geology summary of a well from a document in which the document includes pertinent information in multiple sections and subsections of the document. The document may include a geology section with subsections such as stratigraphy, paleontology, regional setting, hydrocarbon indication, etc., where each contain pertinent information, but which may be scattered throughout the document. The system may rank the pages in the document, select a set of pages from the document, and generate the summary based on the query from the user and the selected pages from the document. Content ranking may also be used to may identify each of the subsections of the sections within a document that are related to a user query, which may then be used to generate a summary of the document.

Systems of the disclosure are technical solutions to the problem of generating relevant document summaries for user queries, addressing limitations of existing language models. The technical nature of the solution involves processing documents and queries. Instead of directly feeding entire documents to the language model (which can lead to issues like limited context length and loss of information), the disclosed systems introduce an intermediate step of ranking document pages based on query relevance. The step involves generating "intermediate data" for ranking, a specific technical process. By selecting the most relevant pages, the system significantly reduces the size of the input for the language model while preserving relevant information. The language model may focus on pertinent content, leading to more accurate and focused summaries. The practical application of the disclosed systems obtain concise, relevant summaries of lengthy documents, improving information retrieval and knowledge discovery across various domains resulting in an improvement to at least the technology of automated summary generation.

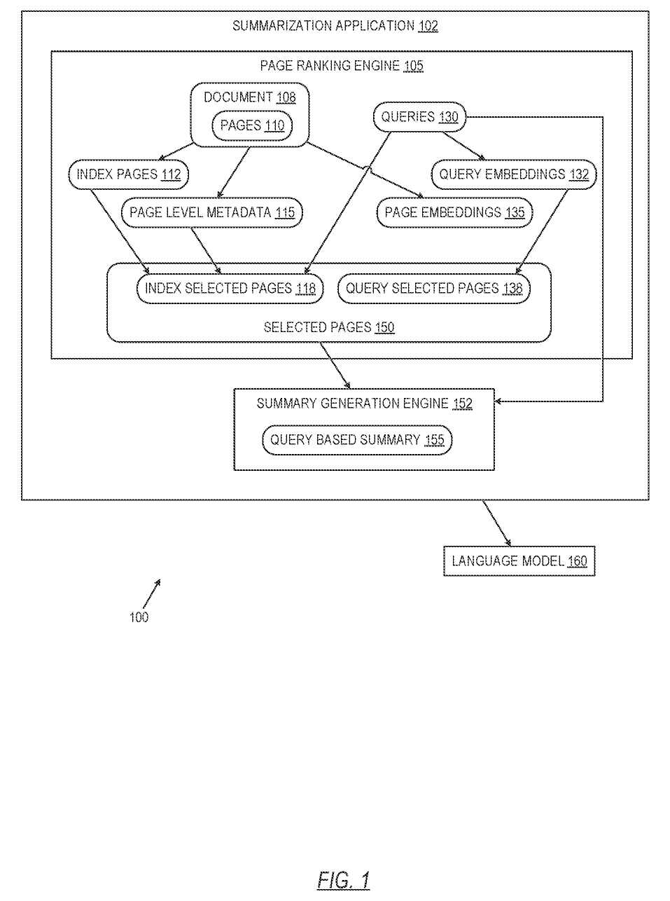

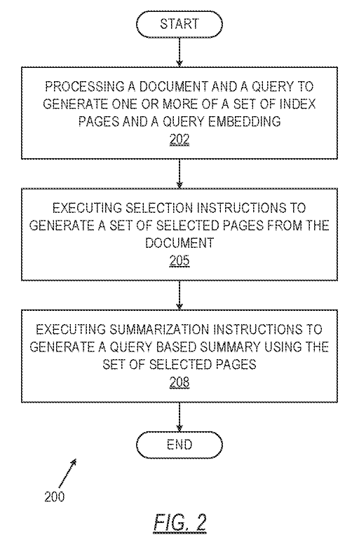

Turning to FIG. 1, the system 100 includes a collection of components that summarize documents with language models using page and content ranking. The system 100 may execute on and incorporate the hardware and software components of the computing system 900 of FIG. 9.1. The system 100 includes the summarization application 102 and the language model 160.

The summarization application 102 is a component that processes the document 108 with the queries 130 to generate the query-based summary 155. The summarization application 102, as well as the components within the summarization application 102, may communicate with the language model 160 to perform natural language processing and may operate with a retrieval augmented generation system involving a vector database. The summarization application 102 includes the page ranking engine 105 and the summary generation engine 152.

The page ranking engine 105 is a component of the summarization application 102. The page ranking engine 105 processes the document 108 and the queries 130 to obtain the selected pages 150. The page ranking engine 105 may use the language model 160 (as well as a vector database with a retrieval augmented generation system) to perform natural language processing to generate the selected pages 150 from the document 108 using the queries 130. The page ranking engine 105 generates the index pages 112 and the page level metadata 115 from the pages 110 of the document 108 and generates the index selected pages 118 from the index pages 112, the page level metadata 115, and the queries 130. The page ranking engine 105 generates the page embeddings 135 from the pages 110 of the document 108 and generates the query embeddings 132 from the queries 130. The query embeddings 132 and the page embeddings 135 are used to generate the query selected pages 138 generated by the page ranking engine 105. The index select pages 118 and the query selected pages 138 may be combined to form the selected pages 150, which may be passed to the summary generation engine 152.

The page ranking engine 105 may also perform content ranking to identify each of the subsections of the sections within the set of index pages that are related to a user query. The ranking may be performed by comparing embeddings generated for the sections and subsections to the query embedding generated from the user query.

The document 108 is a collection of data formed as a contiguous ordered set of data in natural language format. The document 108 may be partitioned into pages and may be queried by a user of the system. The document 108 may include one or more types of data within one or more sections, subsections, figures, text, tables, etc., within the pages 110.

The system 100 may operate on documents of different domains. In the oil and gas domain, the document 108 may include one or more well reports that provide information about wells used to extract subsurface fluids (e.g., oil and gas).

The pages 110 are portions of the document 108. Different types of documents may use different types of pagination. For example, a document may include a page delimiter that identifies the end of a page. As another example, a page may be a specified number of contiguous characters (or bytes of data) from within the document 108. Each of the pages 110 may include one or more types of data in one or more sections, subsections, figures, text, tables, etc.

The index pages 112 are a set of the pages 110 that are extracted from the document 108. The index pages 112 include pages that form one or more of a section listing, a table of contents, an index, etc., from the document 108. For example, the document 108 may include a table of contents, e.g., on pages 3 through 8 of the pages 110, and the pages that form the table of contents may be extracted from the document 108 to form the index pages 112.

The page level metadata 115 includes metadata for each of the pages 110 from the document 108. The metadata, in the page level metadata 115, for one of the pages 110 may include a page number, identifiers for the type of content on the page, section names, etc. The type of content on the page may include tables, figures, logs, etc.

The index selected pages 118 are a set of pages that includes the pages, from the pages 110, that may be identified within the index pages 112 in the page level metadata 115. For example, a table of contents within the index pages 112 may identify a section and a subsection in the document 108 that are relevant to a query and may identify a start page but may not identify each of the pages that form part of the section and a subsection. The index selected pages 118, for the example, may include each page of the pages 110 from the document 108 for the section and subsection.

The queries 130 are text that describe the information to extract (i.e., summarize) from the document 108. For one request from a user, the queries 130 may include a source query and a set of perturbed queries. The source query may be the original query provided by the user through a user interface. The perturbed queries may be variations of the source query that may be generated for the process of selecting the query selected pages 138.

The query embeddings 132 are embeddings generated from the queries 130. One of the query embeddings 132 may correspond to one of the queries 130. Thus, each query may have a corresponding query embedding. For example, there may be a source query embedding generated for a source query of the queries 130 and perturbed query embeddings generated for each of the perturbed queries of the queries 130.

The page embeddings 135 are embeddings generated from the pages 110 of the document 108. One of the page embeddings 135 may correspond to one of the pages 110.

An embedding generated from data (e.g. from one of the queries 130 or one of the pages 110) may include a vector (a list of numbers, which may also be referred to as an embedding vector) generated from the data. An embedding may represent the meaning of a unit of data. An embedding may be generated from a set of token embeddings that represent the semantic meaning of a set of tokens from the original data. The tokens may identify and correspond to symbols words, phrases, etc., from the original data (e.g., from the queries 130 or the pages 110). Symbols, words, phrases, images, etc., with similar meanings may have embeddings with similar values as compared to symbols, words, phrases, images, etc., with dissimilar meaning.

The query selected pages 138 are a set of pages selected from the pages 110. The query selected pages 138 are selected based on comparisons between the query embeddings 132 and the page embeddings 135.

The selected pages 150 are pages selected from the pages 110. The selected pages 150 are used to generate the query-based summary 155. The selected pages 150 include the index selected pages 118 and the query selected pages 138.

The summary generation engine 152 is a component of the summarization application 102. The summary generation engine 152 processes the selected pages 150 with queries 130 to generate the query-based summary 155 using the language model 160. The summary generation engine 152 may generate a prompt, which includes summarization instructions and the selected pages 150, that is sent to the language model 160. The summary generation engine 152 may receive a response from the language model 160 that provides the query-based summary 155 in accordance with the summary instructions using the selected pages 150.

The query-based summary 155 is a summary of the document 108 that is based on the source query (from the user) from the queries 130. The query-based summary 155 may be generated with the language model 160 and provided in a response to a request from the user to generate the query-based summary 155 from the document 108 using the source query.

The language model 160 is a machine learning model that performs natural language processing techniques to generate outputs from given inputs. Interaction with the language model 160 may be through sequences of prompts and responses. A prompt may include data and instructions in which the instructions provide directions to the language model 160 for generating output using the data from the prompt. The language model 160 may utilize one or more types of input and output. For example, the input and output may be text, as well as images, video, audio, etc. The language model 160 may convert inputs to embeddings (i.e., to input embeddings) that represent the meaning of the inputs within a latent space. The input embeddings are further processed by the language model 160 to generate output embeddings, which may then be converted to a different format (text, images, video, audio, etc.), to form the output that is provided as a response to the prompt input to the language model 160. The language model 160 may provide responses to the page ranking engine 105 that include the selected pages 150. The language model 160 may further provide responses to the summary generation engine 152, which may include the query-based summary 155. The output of the language model 160 may use a structured data format (e.g., JavaScript object notation. (JSON)) to organize information within the output using key value pairs.

The language model 160 may have a context length that identifies the size of the input that may be processed when using the language model 160. As an example, the context length may specify the number of tokens (e.g., 10,000 tokens, 100,000 tokens, etc.) that may be used for an input. Tokens may represent different types of information. For example, a token or a set of tokens may represent a symbol, word, phrase, sentence, paragraph, page, table, figure, image, etc., which may be from the document 108.

FIG. 2 shows a flowchart of a method that summarizes documents with language models using page and content ranking. The method of FIG. 2 may be implemented using the systems of FIG. 1, FIG. 9.1, FIG. 9.2, etc. One or more of the steps may be performed on, or received at, one or more computer processors. The system may include at least one processor and an application that, when executing on the at least one processor, performs the method. A non-transitory computer readable medium may include instructions that, when executed by one or more processors, perform the method. The outputs from various components (including models, functions, procedures, programs, processors, etc.) for performing the method may be generated by applying a transformation to inputs using the components to create the outputs without using mental processes or human activities.

Turning to FIG. 2, the process 200 may be used to generate a query-based summary from a document and a query using a language model. The process 200 may include multiple steps (e.g., Block 202 through Block 208) that may execute on the components described in the other figures, including those of FIG. 1.

The process 200 may include receiving, from a user interface, the query and an identification of the document from which to generate the query-based summary. A user of the system may operate a user interface to generate the query and identify the location of the document to process using the query. The identification of the document may also be determined from the query, such as by comparing query embeddings to document or page embeddings for a corpus of documents. The information gathered by the user interface may then be sent in a request to a software application that generates a response that includes the query-based summary generated from the document using the query.

Block 202 includes processing a document and a query to generate one or more of a set of index pages and a query embedding. The set of index pages may be generated or obtained from the document by prompting a language model to identify whether the document includes index pages (e.g., a table of contents or an index). A retrieval augmented generation system with vector database may also be used for iterative page selection of the index pages. The language model may further extract the index pages from the document responsive to the prompt. The query embedding may be generated from the query using an embedding model of the language model. The embedding model may extract the text of the query, convert the text to tokens (one token may represent a symbol, word, phrase, or other term, from the query), convert each token to a token embedding, and convert the sequence of token embeddings to a single vector embedding that forms the query embedding.

Processing the document to obtain the index pages may further include sending a set of initial pages from the document to a language model. The language model may have a limited context window such that the content from the full document may not fit within the context window of the language model. Pages from the document may be selected of a size that fits within the context window of the language model and sent to the language model with instructions to identify and extract index pages from the initial pages. The number of pages may be specified (e.g., 20) or determined based on the size the context window of the language model compared to the number of vector embeddings that represent the initial pages. The initial pages may be at the beginning (i.e., head end) of the document. Concluding pages (i.e., from the tail end of the document) may also be processed similar to the initial pages to identify index pages from the document.

Processing the document may further include extracting the set of index pages including one or more of a table of contents and an index from the document using one or more of the set of initial pages and a set of page embeddings. The language model may be directed to extract the index pages with a prompt that includes extraction instructions and the initial pages. Responsive to the prompt, the language model may identify the index pages from the initial pages and output the index pages. When the initial pages do not include index pages (e.g., do not include a table of contents of index), a retrieval augmented generation system may identify the index pages from the page embeddings that represent the pages of a document. The identification may be performed by comparing the page embeddings generated for the pages of a document to a set of predefined index embeddings that represent tables of contents or indexes from multiple documents. The comparison may also be done with page embeddings compared against the embedding of a natural language query (e.g., “get me index /table of content from the document”), which may be generated as an intermediate query in addition to the actual user query. Using the retrieval augmented generation system may collect index pages that are scattered throughout a document. The output of the index pages may be in a structured data format, such as JavaScript object notation (JSON).

Processing the document may further include extracting page level metadata from the document. The page level metadata includes, for each page from the document, one or more of a page number, a section name, a table, and a figure present on each page. The language model may be prompted to generate the page level metadata with a prompt that includes metadata extraction instructions and the page from which to extract the metadata. A deterministic program may also be used to generate the page level metadata by identifying and recording the types of data on each page.

Processing the document may further include storing page embeddings generated from pages from the document to a vector database. Each page of the document may be converted to one or multiple embeddings. A single embedding may represent the content of the page of the document. With multiple embeddings, each embedding may represent a different piece of information from the page of the document. A piece of information represented by an embedding may include a unit of text, a unit of an image, etc. A unit of text may be a symbol, word, phrase, sentence, paragraph, etc., from the page. A unit of an image may be a sub image from the image. The page itself may be an image or may include multiple images with text.

Processing the query may further include generating the query embedding from the query. The query embedding may be generated by converting text from the query to tokens that are converted to token embeddings. The set of token embeddings (which may represent words from text from the query) may be used as the query embedding itself. Additionally, the set of token embeddings may be aggregated into a single embedding to form the query embedding.

Processing the document and the query may further include performing content identification on the document responsive to the query from a user interface, to identify the set of index pages. The content identification may identify the location of the types of data within the document, such as the location of the table of contents or of the index within the document. Content identification may be performed in response to receiving a query from the user with the document. The sections, subsections, bullet points, etc., may be obtained from the set of index pages or from metadata.

Block 205 includes executing selection instructions to generate a set of selected pages from the document. The set of selected pages includes the one or more of a set of index selected pages and a set of query selected pages. The set of index selected pages are selected using the set of index pages. The set of query selected pages are selected using the query embedding. The content ranking is a mechanism that may identify each of the subsections of the sections within the set of index pages that are related to user query. The ranking may be performed by comparing embeddings generated for the sections and subsections to the query embedding generated from the user query. The content ranking is done based on document metadata which contains a list of the sections and subsections with page numbers, information from the index pages, and user query.

The selection instructions may include instructions within a prompt to the language model that directs the language model to select, from a set of index pages, a set of index selected pages in which the index selected pages are pertinent to the query. The query in this case may be the query from the user or an internal query generated by the system that is used to select the index selected pages. The determination of whether an index page is an index selected page is made by the language model as a part of the output from the language model.

Executing the selection instructions may further include performing section identification on the document based on the content identification and page level metadata to identify the set of index selected pages. The section identification may be performed by the language model when prompted to identify the different sections within the document. The sections identified by the language model may include the table of contents and index as well as the sections identified by different headings and subsections identified by different subheadings within the document as well as the metadata extracted from the document.

Executing the selection instructions may further include constructing a section selection prompt including one or more of the query, the set of index selected pages, page level metadata, and section selection instructions to identify a set of page numbers for the set of index selected pages corresponding to one or more sections and subsections from the document related to the query. The section selection prompt may include natural language instructions that directs the language model to identify the page numbers that are relevant to each section based on the query, the index selected pages, and the page level metadata.

Executing the selection instructions may further include executing a section selection prompt with a language model to generate a set of page numbers from the set of index selected pages. The page numbers are identified by the language model from the page numbers in one or more of the table of contents of the document, the index of the document, and the page level metadata generated from the document.

Executing the selection instructions may further include filtering the pages by comparing the page embeddings with the query embedding using a similarity threshold to identify a set of filtered pages. A program may generate the page embeddings and the query embeddings and then perform a comparison of the embeddings to filter the pages. The filtered pages may be the pages with similarity values that are above the similarity threshold and are more similar to the query than the pages with similarity values below the similarity threshold.

Executing the selection instructions may further include removing a set of filtered pages from a set of document pages of the document to generate a set of unfiltered pages. The removal may be performed by a program responsive to the identification of the filtered pages. The unfiltered pages are the pages whose similarity values with the query or below the similarity threshold.

Executing the selection instructions may further include perturbing the query to generate a perturbed query. The query is perturbed to increase the likelihood of identifying relevant pages for summarization. Certain pages may contain relevant information using different terms or phrase from the original query, which may be identified with a perturbed query. Perturbing the query may be performed starting from text (i.e., the text space) or starting from an embedding (i.e., in the latent space of the embeddings that represent the meaning of units of content from the document). When starting from text, the query may be perturbed by prompting the language model to change the text of the source query (the inquiry originally received with the document from the user), for example, by using different words but keeping the same meaning of the query. When starting from an embedding, the embedding that represents the query (which may be a single vector embedding or a set of token embeddings) may be modified by adding noise to the values in the embedding.

Executing the selection instructions may further include generating a perturbed query embedding from the perturbed query. When starting from text to generate the perturbed query, the text from the perturbed query is converted to an embedding to form the perturbed query embedding.

Executing the selection instructions may further include filtering the set of unfiltered pages by comparing page embeddings for the set of unfiltered pages with the perturbed query embedding using a similarity threshold to identify a second set of filtered pages. The second set of filtered pages are identified after the first set of filtered pages are removed from the document pages. The first and second filtered pages may form part of the selected pages that are used to generate the query based summary.

Block 208 includes executing summarization instructions to generate a query-based summary using the set of selected pages and content ranking. The summarization instructions may include a prompt with natural language instructions or the machine code instructions of a program. The natural language instructions may be executed by the language model, and the machine code instructions may be executed by a processor. The machine code instructions may construct a prompt that includes the natural language instructions along with the selected pages to be processed by the language model.

Executing the summarization instructions may further include performing section summarization to generate the query based summary of the document using the set of selected pages, which may include a set of index selected pages. The section summarization may summarize one or more sections from the document that are included in the selected pages.

Executing the summarization instructions may further include constructing a summarization prompt including the set of selected pages and the summarization instructions. The set of selected pages includes a set of filtered pages and a second set of filtered pages. There may be multiple sets of filtered pages. The summarization prompt includes natural language instructions that requests generating the query based summary using the set of filtered pages and the second set of filtered pages that may be included within the summarization prompt.

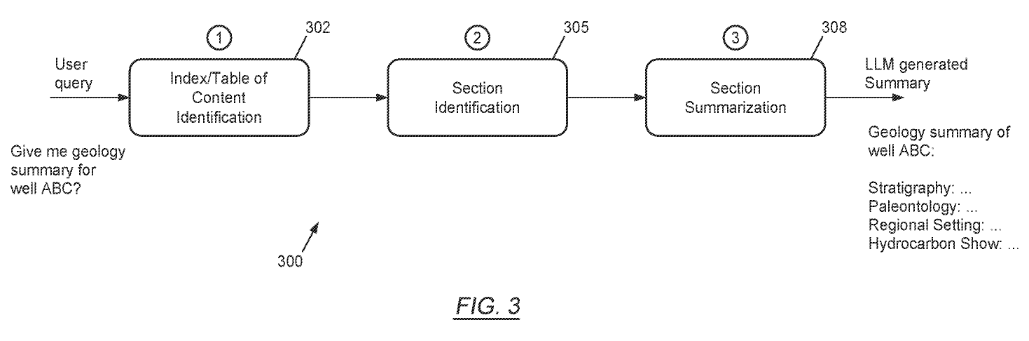

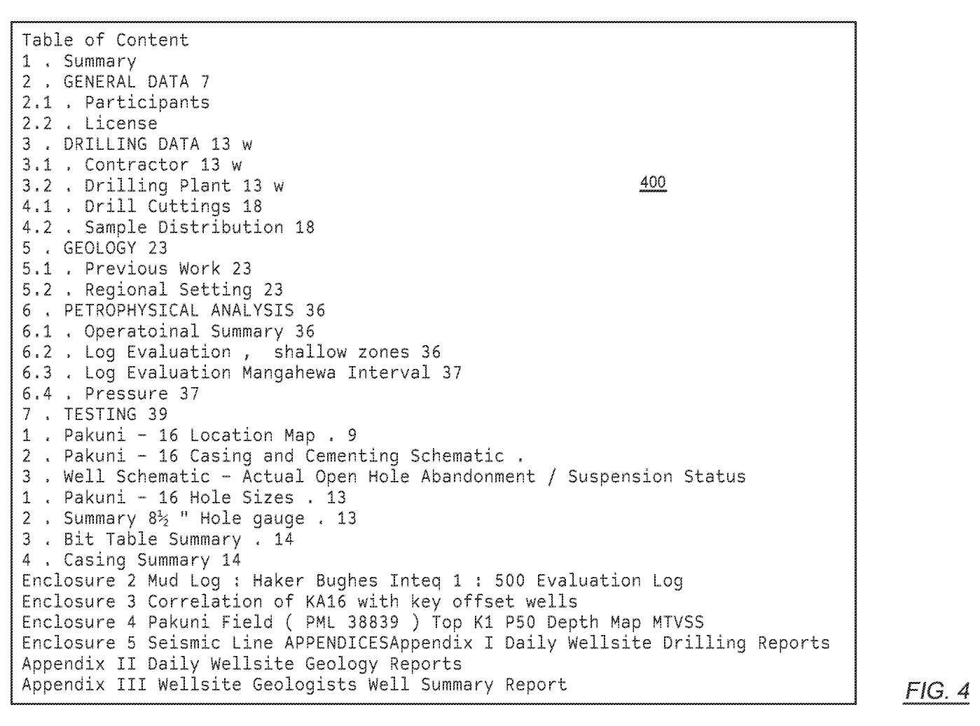

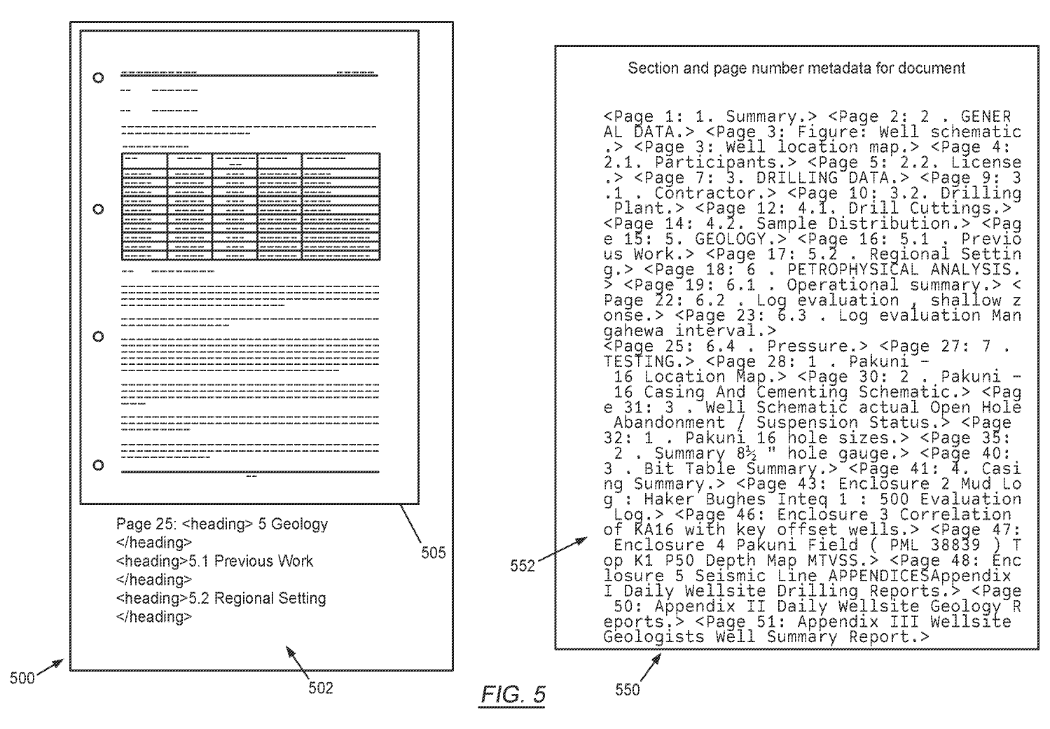

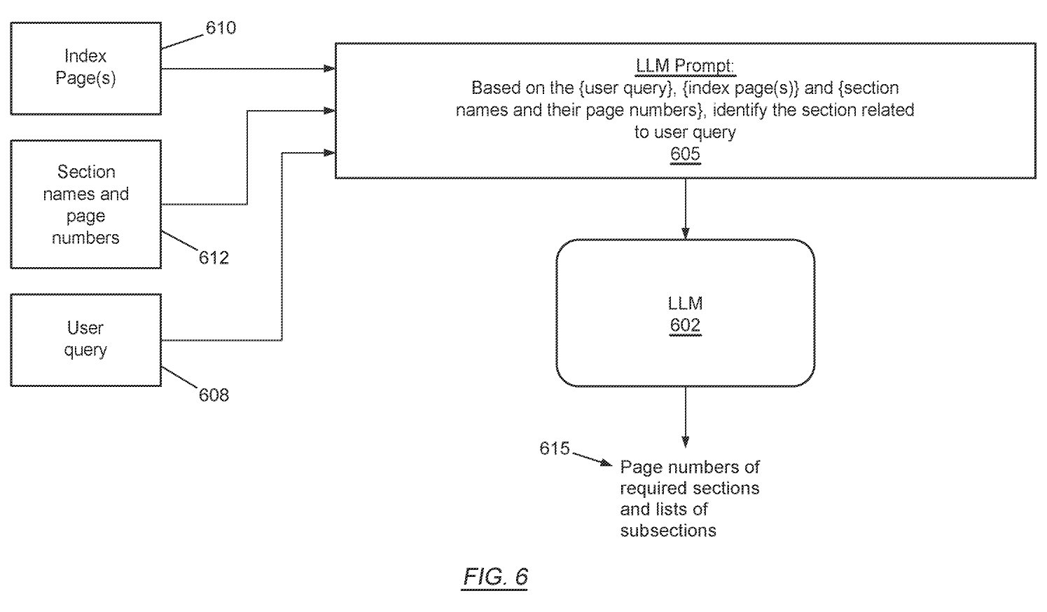

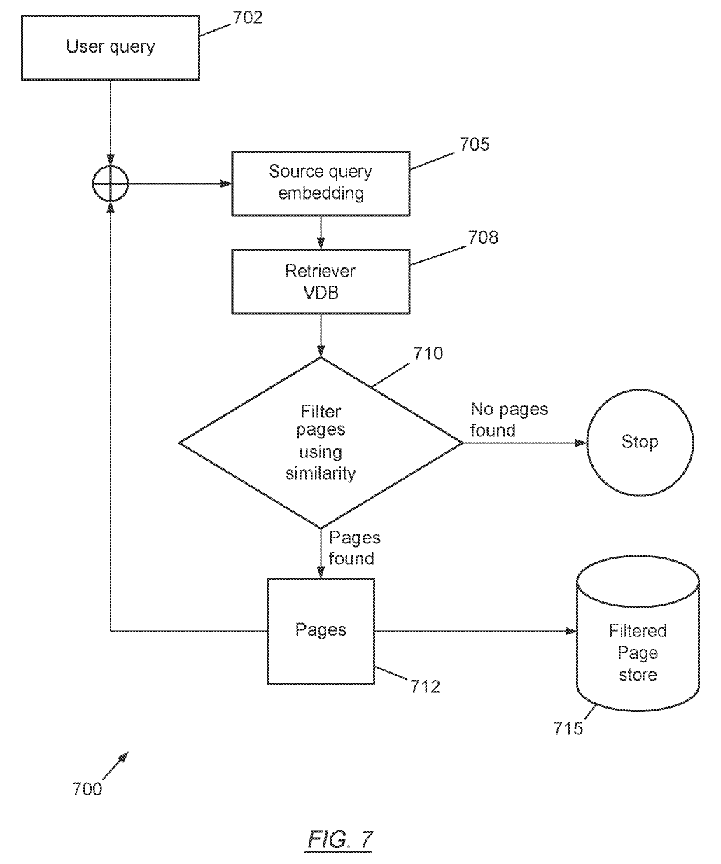

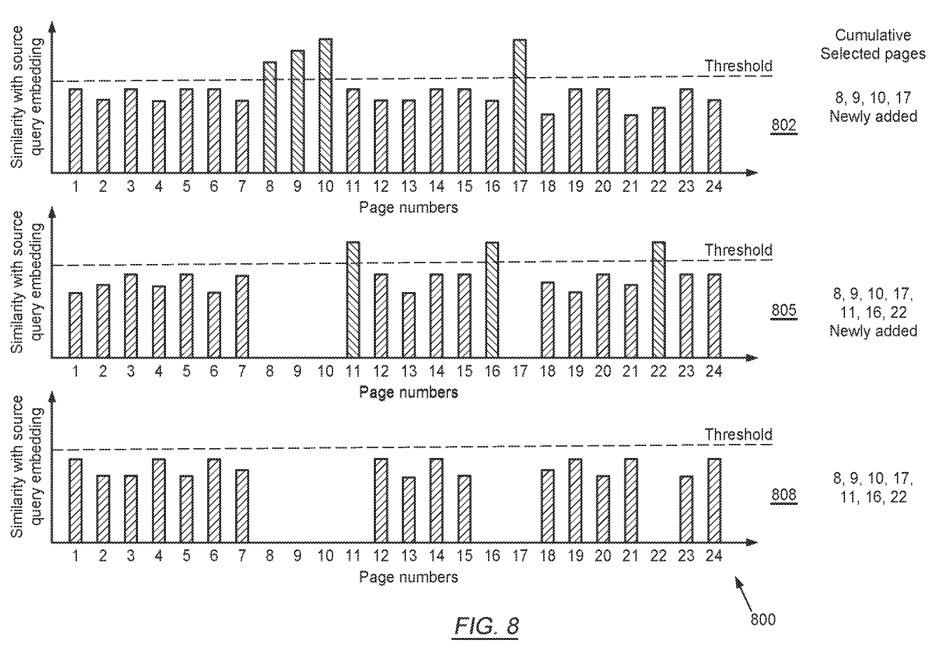

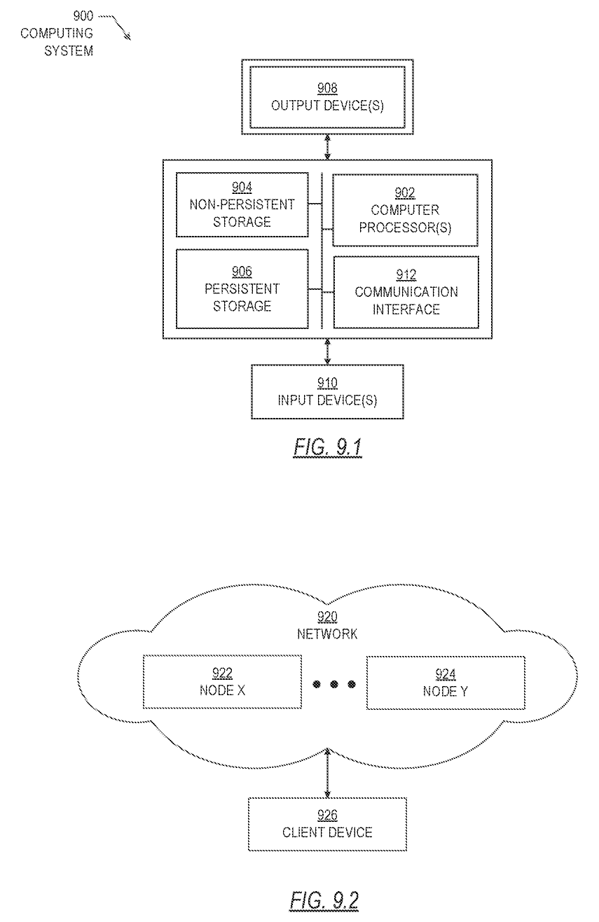

Turning to FIG. 3, the workflow 300 may be used for document summarization using a language model. The workflow 300 includes the blocks 302, 305, and 308.

At Block 302, the table of contents or index of the document is identified. A large document may contain an index or table of contents showing the various sections and subsections along with their page numbers. In the first step, the index pages are identified to extract the document index.

At Block 305, the relevant sections of the document are identified based on the query from the user (i.e., the user query) received through a user interface. As content for summarization may span multiple pages, the pages may be ranked to be used for summarization based on the user query and the index of the document as identified in Block 302. Once the pages are ranked, the contents from the selected pages are sent to the language model for summarization. Block 305 also identifies relevant subsections based on the user query that are considered as the relevant parts of the document for summarization. The relevant subsections may be identified based on a user query and a table of contents of the document that was identified in Block 302. For example, if a user asks for geology of a well, then the table of contents may include a geology section with subsections as formations, paleontology (typical subsections under geology). The subsections under the geology section may be identified from user query and table of content.

At Block 308, section summarization is performed. The language model is prompted to summarize the contents of the top ranked pages, i.e., the pages identified as relevant to the query. The language model may also receive the relevant points from the document to be used during summarization.

Turning to FIG. 4, the text 400 shows an example of the table of contents extracted from a document. The text 400 may be displayed in a user interface. The index pages for the table of contents or index (or the like) of the document is extracted using a language model. The index pages may be present in the first few pages of the document, i.e., in the initial pages at the head of the document. The initial pages (e.g., the textual contents of the first 10 pages of the document) are sent to the language model, that is prompted to identify and extract the table of contents. The language model may have a context window to accommodate text from the initial 10-15 pages from the document. If an index or table of contents is not present in initial pages (i.e., the first 10-15 pages), retrieval augmented generation may be used to obtain the index pages. The language model may identify and extract the index pages since index pages include structure recognizable to the language model that makes the text in the index pages distinguishable from other text from the document.

Turning to FIG. 5 the window 500 and the window 550 may be displayed on a user interface. The window 500 shows the page level metadata 502 containing a page number and section names identified by a language model from the page 505 of a document. The window 550 shows document level metadata that contains page level metadata for each page of the document.

The page level metadata may be used in section identification. Section identification is a step in summarization where each page in a document may be ranked to select appropriate pages for summarization. Sections may be identified using information from at least two sources: from an index of the document that lists the sections and subsections present in the document and from page level metadata for all pages, which contains information about section headings.

The index (or table of contents) of the document as extracted (e.g., Block 302 of FIG. 3) and describes each of the sections and subsections present in the document. However, some page numbers of the sections and subsections as presented in the index may not properly match the document page number. Pages may be stored as embeddings (as page embeddings, as sets of token embeddings, etc.) in a vector database based on metadata such as page numbers. Hence, to accurately identify the page numbers of the document from the original file (e.g., from a structured format such as the portable document format (PDF)) and rank the pages, the page level metadata may be used in addition to the pagination (i.e., page numbering) information from the index (or table of contents).

Page level metadata (including the page level metadata 502) includes the section names and the page number for each page. The section names may be identified using natural language processing methods such as by using language models for section name identification from text, by using visual element detection models to detect paragraphs, tables, section headings, etc., from page images, etc. The window 500 shows the metadata for a single page (the page 505) which contains page number and section headings separated by headings tags. The window 550 shows the page level metadata for each page of a document. The document level metadata 552 (which may be a collection of the page level metadata for each page of a document) provides information about the section (names) with respective page numbers.

Due to the stochastic nature of artificial intelligence (AI) models (including language models) may imperfectly identify the section and subsection names directly from page level metadata and document level metadata. The imperfection of extracting section and subsection names from the metadata may be resolved by extracting the table of contents or index (due to textual structure thereof) and hence to extract each of the sections and subsection names of the document.

The two sources of information (e.g., the metadata and the index information) may be selectively used by prompting the language model to focus on one or the other, i.e., on section and subsection names from index information (i.e., from the table of contents or index extracted from the document) or on page numbers from document level metadata. The language model may be prompted to associate these two sources of information and identify the sections from the document that are relevant to the user query.

Turning to FIG. 6, the workflow 600 is an example of a workflow for a section and content identification step (e.g., Block 305 of FIG. 3). The language model 602 may be prompted (with the prompt 605, referred to as an “LLM Prompt”) to list each of the subsection names for a given section identified as being related to the source query from the user (e.g., the user query 608). The subsection names subsequently guide the language model to summarize the important contents of the section/document (e.g., Block 308 of FIG. 3).

A section identification process may use the language model 602 that takes as input the user query 608, the index page 610, and document level metadata (section names and page numbers 612) to output the numbers of the pages to be used for summarization 615 (in which the pages identified may be referred to as top ranked pages). The section identification process of the workflow may act as a page ranking mechanism for summarization. Additionally, the content identification process may identify each of the subsections of the sections related to user query to act as a content ranking mechanism.

Turning to FIG. 7, page ranking may be performed without using index information or page level metadata. Page ranking may also be performed to identify index pages. The two methods of page ranking may also be combined. Page ranking may be performed with an iterative method. The workflow 700 implements a page ranking algorithm where document pages are filtered based on similarity of page embeddings with the source query embedding 705 of the user query 702.

The workflow 700 iteratively checks similarity of source query embedding 705 with the embeddings of document pages. The workflow 700 uses a vector database which stores the embeddings of pages of the document.

The process starts with the user query 702 which is embedded using an embedding model to generate source query embedding. Using the vector database retriever 708, embeddings of each (or the top k, where k is a predetermined number, e.g., 20) pages are retrieved. The source query embedding 705 is then matched with the embeddings of all (or top k of) the pages in the document. The pages, whose embeddings have high similarity with the source query embedding 705 are filtered 710. The filtered pages 712 may then be augmented with the user query 702 to generate a perturbed query. An embedding for the perturbed query is obtained and the process of filtering pages based on similarity between the page embedding and the query embedding is repeated until no additional pages are filtered and stored to the filtered page store 715. At the end, the filtered pages from each iteration are collected and identified as top ranked pages for summarization for the given user query.

The perturbation of an original query can be performed using user query augmentation where user query is rephrased. Perturbation may also be performed by combining the contents of filtered pages with the user query. Perturbation may also be performed in the latent space of the embeddings by injecting noise into the embedding for the user query 702.

Turning to FIG. 8, a step-by-step illustration of page ranked filtering may be displayed in the user interface 800. The ranking may be based on similarity of source query embedding and page embeddings. The x axis shows the page numbers, and the y axis shows the similarity of source query embedding with each page embedding. The height of each bar represents the similarity of the embedding of a page to the embedding of a query. In each of the iterations 802, 805, and 808, the query embedding that is compared with embeddings from the pages of the document may be different. The query embedding for the iteration 802 may be the embedding for the source query from the user. The query embedding for the iteration 805 may be for a perturbed query generated from the source query. The query embedding for the iteration 808 may be for a second perturbed query. The second perturbed query may be generated from the source query or from the first perturbed query. The different perturbed queries may be generated with different methods. For example, the first perturbed query may be generated using natural language processing and the second perturbed query may be generated by injecting noise into the query embeddings generated from either the source query or the first perturbed query.

For the first iteration 802, the pages 8, 9, 10, and 17 are filtered (and may be shaded with red colored bars as compared to blue colored bars for the remaining pages) if the similarity score is higher than the threshold. The same threshold may be used for each of the iterations 802, 805, and 808. In the next iteration 805, the previously filtered pages (i.e., the pages 8, 9, 10, and 17) are removed while calculating similarity score of page embeddings with new query embeddings. In each iteration, filtered pages are collected, and at the end of the iterative process, each of the filtered pages are identified as top ranked pages for summarization. In each iteration, the query (or corresponding embedding) used for comparison is different (i.e., perturbed) from the queries or embeddings used in previous iterations.

Embodiments may be implemented on a special purpose computing system specifically designed to achieve the improved technological result. Turning to FIG. 9.1 and FIG. 9.2, the special purpose computing system 900 may include one or more computer processors 902, non-persistent storage 904, persistent storage 906, a communication interface 912 (e.g., Bluetooth interface, infrared interface, network interface, optical interface, etc.), and numerous other elements and functionalities that implement the features and elements of the disclosure. The computer processor(s) 902 may be an integrated circuit for processing instructions. The computer processor(s) 902 may be one or more cores or micro-cores of a processor. The computer processor(s) 902 includes one or more processors. The one or more processors may include a central processing unit (CPU), a graphics processing unit (GPU), a tensor processing unit (TPU), combinations thereof, etc.

The input device(s) 910 may include a touchscreen, keyboard, mouse, microphone, touchpad, electronic pen, or any other type of input device. The input device(s) 910 may receive inputs from a user that are responsive to data and messages presented by the output device(s) 908. The inputs may include text input, audio input, video input, etc., which may be processed and transmitted by the computing system 900 in accordance with the disclosure. The communication interface 912 may include an integrated circuit for connecting the computing system 900 to a network (not shown) (e.g., a local area network (LAN), a wide area network (WAN) such as the Internet, mobile network, or any other type of network), and/or to another device, such as another computing device.

Further, the output device(s) 908 may include a display device, a printer, external storage, or any other output device. One or more of the output device(s) 908 may be the same or different from the input device(s) 910. The input device(s) 910 and the output device(s) 908 may be locally or remotely connected to the computer processor(s) 902. Many different types of computing systems exist, and the aforementioned input device(s) 910 and output device(s) 908 may take other forms. The output device(s) 908 may display data and messages that are transmitted and received by the computing system 900. The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system 900 in FIG. 9.1 may be connected to or be a part of a network. For example, as shown in FIG. 9.2, the network 920 may include multiple nodes (e.g., node X 922 and node Y 924). Each node may correspond to a computing system, such as the computing system 900 shown in FIG. 9.1, or a group of nodes combined may correspond to the computing system 900 shown in FIG. 9.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system 900 may be located at a remote location and connected to the other elements over a network.

The nodes (e.g., node X 922 and node Y 924) in the network 920 may be configured to provide services for a client device 926, including receiving requests and transmitting responses to the client device 926. For example, the nodes may be part of a cloud computing system. The client device 926 may be a computing system, such as the computing system 900 shown in FIG. 9.1. Further, the client device 926 may include and/or perform all or a portion of one or more embodiments of the disclosure.

The computing system 900 of FIG. 9.1 may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or a semi permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an “or” may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well known features have not been described in detail to avoid unnecessarily complicating the description. Further, other embodiments not explicitly described above may be devised which do not depart from the scope of the claims as disclosed herein. Accordingly, the scope should be limited only by the attached claims.

What is claimed is:

1. A method comprising:
processing a document and a query to generate one or more of a set of index pages and a query embedding;
executing selection instructions to generate a set of selected pages from the document, wherein the set of selected pages comprises the one or more of a set of index selected pages and a set of query selected pages, wherein the set of index selected pages are selected using the set of index pages, and wherein the set of query selected pages are selected using the query embedding; and
executing summarization instructions to generate a query based summary using the set of selected pages and content ranking.

2. The method of claim 1, further comprising:
performing content identification on the document responsive to the query from a user interface, to identify the set of index pages;
performing section identification on the document based on the content identification and page level metadata to identify the set of index selected pages; and
performing section summarization to generate the query based summary of the document using the set of index selected pages.

3. The method of claim 1, further comprising:
receiving, from a user interface, the query and an identification of the document from which to generate the query based summary.

4. The method of claim 1, wherein processing the document comprises:
sending a set of initial pages from the document to a language model; and
extracting the set of index pages comprising one or more of a table of contents and an index from the document using one of more of the set of initial pages and a set of page embeddings.

5. The method of claim 1, wherein processing the document comprises:
extracting page level metadata from the document,
wherein the page level metadata comprises, for each page from the document, one or more of a page number, a section name, a table, and a figure present on each page.

6. The method of claim 1, wherein executing the summarization instructions comprises:
constructing a section selection prompt comprising one or more of the query, the set of index selected pages, page level metadata, and section selection instructions to identify a set of page numbers from the set of index selected pages corresponding to one or more sections and subsections from the document related to the query.

7. The method of claim 1, wherein executing the selection instructions comprises:
executing a section selection prompt with a language model to generate a set of page numbers from the set of index selected pages.

8. The method of claim 1, further comprising:
wherein processing the document and the query comprises:
storing page embeddings generated from pages from the document to a vector database, and
generating the query embedding from the query; and
wherein executing the selection instructions comprises:
filtering the pages by comparing the page embeddings with the query embedding using a similarity threshold to identify a set of filtered pages.

9. The method of claim 1, wherein executing the selection instructions comprises:
removing a set of filtered pages from a set of document pages of the document to generate a set of unfiltered pages;
perturbing the query to generate a perturbed query;
generating a perturbed query embedding from the perturbed query; and
filtering the set of unfiltered pages by comparing page embeddings for the set of unfiltered pages with the perturbed query embedding using a similarity threshold to identify a second set of filtered pages.

10. The method of claim 1, wherein executing the summarization instructions comprises:
constructing a summarization prompt comprising the set of selected pages and the summarization instructions,
wherein the set of selected pages comprises a set of filtered pages and a second set of filtered pages.

11. A system comprising:
at least one processor; and
an application that, when executing on the at least one processor, performs stored operations comprising:
processing a document and a query to generate one or more of a set of index pages and a query embedding,
executing selection instructions to generate a set of selected pages from the document, wherein the set of selected pages comprises the one or more of a set of index selected pages and a set of query selected pages, wherein the set of index selected pages are selected using the set of index pages, and wherein the set of query selected pages are selected using the query embedding, and
executing summarization instructions to generate a query based summary using the set of selected pages and content ranking.

12. The system of claim 11, further comprising:
performing content identification on the document responsive to the query from a user interface, to identify the set of index pages;
performing section identification on the document based on the content identification and page level metadata to identify the set of index selected pages; and
performing section summarization to generate the query based summary of the document using the set of index selected pages.

13. The system of claim 11, further comprising:
receiving, from a user interface, the query and an identification of the document from which to generate the query based summary.

14. The system of claim 11, wherein processing the document comprises:
sending a set of initial pages from the document to a language model; and
extracting the set of index pages comprising one or more of a table of contents and an index from the document using one of more of the set of initial pages and a set of page embeddings.

15. The system of claim 11, wherein processing the document comprises:
extracting page level metadata from the document,
wherein the page level metadata comprises, for each page from the document, one or more of a page number, a section name, a table, and a figure present on each page.

16. The system of claim 11, wherein executing the summarization instructions comprises:
constructing a section selection prompt comprising one or more of the query, the set of index selected pages, page level metadata, and section selection instructions to identify a set of page numbers from the set of index selected pages corresponding to one or more sections and subsections from the document related to the query.

17. The system of claim 11, wherein executing the selection instructions comprises:
executing a section selection prompt with a language model to generate a set of page numbers from the set of index selected pages.

18. The system of claim 11, further comprising:
wherein processing the document and the query comprises:
storing page embeddings generated from pages from the document to a vector database, and
generating the query embedding from the query; and
wherein executing the selection instructions comprises:
filtering the pages by comparing the page embeddings with the query embedding using a similarity threshold to identify a set of filtered pages.

19. The system of claim 11, wherein executing the selection instructions comprises:
removing a set of filtered pages from a set of document pages of the document to generate a set of unfiltered pages;
perturbing the query to generate a perturbed query;
generating a perturbed query embedding from the perturbed query; and
filtering the set of unfiltered pages by comparing page embeddings for the set of unfiltered pages with the perturbed query embedding using a similarity threshold to identify a second set of filtered pages.

20. A non-transitory computer readable medium comprising stored instructions executable by at least one processor to perform:
processing a document and a query to generate one or more of a set of index pages and a query embedding;
executing selection instructions to generate a set of selected pages from the document, wherein the set of selected pages comprises the one or more of a set of index selected pages and a set of query selected pages, wherein the set of index selected pages are selected using the set of index pages, and wherein the set of query selected pages are selected using the query embedding; and
executing summarization instructions to generate a query based summary using the set of selected pages and content ranking.
